(19) United States
(12) Patent Application Publication
(10) Pub. No.: US 2026/0323037 A1
(43) Pub. Date: Oct. 15, 2026

(54) INTER PREDICTION IN VIDEO CODING

(71) Applicant: MEDIATEK INC., Hsinchu City (TW)

(72) Inventors: Yi-Wen CHEN, San Jose, CA (US); Olena CHUBACH, San Jose, CA (US); Ching-Yeh CHEN, Hsinchu City (TW); Tzu-Der CHUANG, Hsinchu City (TW)

(21) Appl. No.: 19/117,259

(22) PCT Filed: Sep. 21, 2023
(86) PCT No.: PCT/CN2023/120263

§ 371 Date: Mar. 31, 2025

Related U.S. Application Data
(60) Provisional application No. 63/378,372, filed on Oct. 5, 2022.

(51) Int. Cl. H04N 19/159

(52) U.S. Cl. CPC H04N 19/159

(57) ABSTRACT

A method for performing inter prediction in a video decoder is provided. The method includes receiving a coding unit in a bitstream of a video. The coding unit is coded with a Template Matching (TM) process and a Bilateral Matching (BM) process. The method also includes determining an order of the TM and BM processes. The method further includes performing, based on the determined order of the TM and BM processes, inter prediction to reconstruct the received coding unit.

### CROSS REFERENCE TO RELATED APPLICATIONS

This present application claims the benefit of provisional Application No. 63/378,372, filed on Oct. 5, 2022. The disclosure of the prior application is incorporated herein by reference in its entirety.

### TECHNICAL FIELD

The present disclosure relates generally to video encoding and decoding.

### BACKGROUND

The demand for powerful video coding techniques is increasing, especially with the growing needs for efficient video data transmission and storage. After the Versatile Video Coding (VVC) standard is finalized, the video coding community aims to standardize future video coding technologies. As part of the effort, a common software test platform, Enhanced Compression Model (ECM), has been developed to explore the potential standardization of advanced video coding techniques.

Many inter coding tools have been studied on top of ECM to evaluate their functions and performance and to decide whether or not to adopt them in ECM. For example, in order to provide further Bjontegaard Delta-Rate savings, the current ECM includes a set of inter-prediction coding tools, including Template Matching (TM), Multi-Pass Decoder-side Motion Vector Refinement (or Bilateral Matching (BM)), Local Illumination Compensation (LIC), Non-Adjacent Spatial Candidate, Overlapped Block Motion Compensation (OBMC), Multi-Hypothesis Prediction (MHP), Bilateral Matching AMVP-Merge Mode, etc.

### SUMMARY

Aspects of the disclosure provide a method for performing inter prediction in a video decoder. The method includes receiving a coding unit in a bitstream of a video. The coding unit is coded with a Template Matching (TM) process and a Bilateral Matching (BM) process. The method also includes determining an order of the TM and BM processes. The method further includes performing, based on the determined order of the TM and BM processes, inter prediction to reconstruct the received coding unit.

Aspects of the disclosure provide another method for performing inter prediction in a video encoder. The method includes performing, based on a determined order of a Template Matching (TM) process and a Bilateral Matching (BM) process, inter prediction to code a coding unit. The method also includes transmitting the coded coding unit in a bitstream of a video.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a video encoder according to an embodiment of the disclosure;

FIG. 2 shows a block diagram of a video decoder according to an embodiment of the disclosure;

FIGS. 3A and 3B show flow charts of processes for performing inter prediction in a video encoder and a video decoder, respectively, in accordance with embodiments of the disclosure;

FIG. 4 shows multiple types of tree splitting modes;

FIG. 5 shows an example of quadtree with nested multi-type tree coding block structure;

FIG. 6 shows a search point layout in the Merge mode with Motion Vector Difference (MMVD);

FIGS. 7A and 7B show control-point-based 4-parameter and 6-parameter affine motion models, respectively;

FIG. 8 shows an example of an affine motion vector field (MVF) per subblock;

FIG. 9 shows locations of inherited affine motion predictors;

FIG. 10 shows an example of control point motion vector inheritance;

FIG. 11 shows locations of candidate positions for the constructed affine merge mode;

FIG. 12 shows an example of Decoder-Side Motion Vector Refinement (DMVR);

FIG. 13 shows examples of the geometric partition mode (GPM) splits grouped by identical angles;

FIG. 14 shows top and left neighboring blocks used in the Combined Inter-Intra Prediction (CIIP) weight derivation.

FIG. 15 shows Template Matching (TM) performed on a search area around an initial motion vector (MV); and

FIG. 16 shows 5 diamond-shape search regions in the search area of the second pass of multi-pass DMVR.

### DETAILED DESCRIPTION OF EMBODIMENTS

The following disclosure provides different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

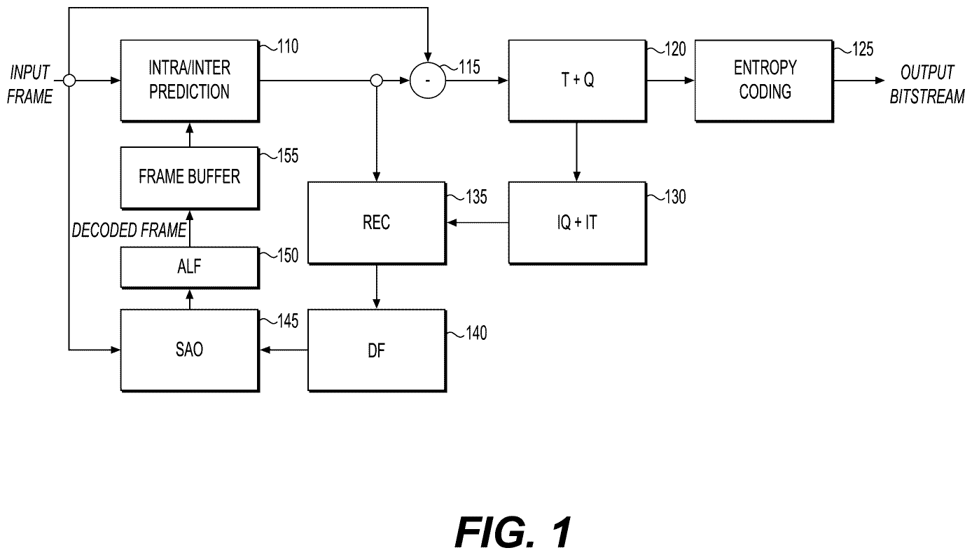

FIG. 1 shows a block diagram of a video encoder that can include or be coupled to a module or circuit implementing the methods and techniques described in the disclosure. The video encoder may be implemented based on the Versatile Video Coding (VVC) standard, the High-Efficient Video Coding (HEVC) standard (with Adaptive Loop Filter (ALF) added) or any other video coding standard. The Intra/Inter Prediction unit 110 generates Inter prediction based on Motion Estimation (ME)/Motion Compensation (MC) when Inter mode is used. The Intra/Inter Prediction unit 110 generates Intra prediction when Intra mode is used. The Intra/Inter prediction data (i.e., the Intra/Inter prediction signal) is supplied to the subtractor 115 to form prediction errors, also called “residues” or “residual”, by subtracting the Intra/Inter prediction signal from the signal associated with the input frame. The process of generating the Intra/Inter prediction data is referred as the prediction process in this disclosure. The prediction error (i.e., the residual) is then processed by Transform (T) followed by Quantization (Q) (T+Q, 120). The transformed and quantized residues are then coded by Entropy Coding unit 125 to be included in a video bitstream corresponding to the compressed video data.

The bitstream associated with the transform coefficients is then packed with side information such as motion, coding modes, and other information associated with the image area. The side information may also be compressed by entropy coding to reduce required bandwidth. Since a reconstructed frame may be used as a reference frame for Inter prediction, a reference frame or frames have to be reconstructed at the encoder end as well. Consequently, the transformed and quantized residues are processed by Inverse Quantization (IQ) and Inverse Transformation (IT) (IQ+IT, 130) to recover the residues. The reconstructed residues are then added back to Intra/Inter prediction data at Reconstruction unit (REC) 135 to reconstruct video data. The process of adding the reconstructed residual to the Intra/Inter prediction signal is referred as the reconstruction process in this disclosure. The output frame from the reconstruction process is referred as the reconstructed frame.

In order to reduce artefacts in the reconstructed frame, in-loop filters, including but not limited to, Deblocking Filter (DF) 140, Sample Adaptive Offset (SAO) 145, and Adaptive Loop Filter (ALF) 150 are used. In this disclosure, DF, SAO, and ALF are all labeled as a filtering process. The filtered reconstructed frame at the output of all filtering processes is referred as a decoded frame in this disclosure. The decoded frames are stored in Frame Buffer 155 and used for prediction of other frames.

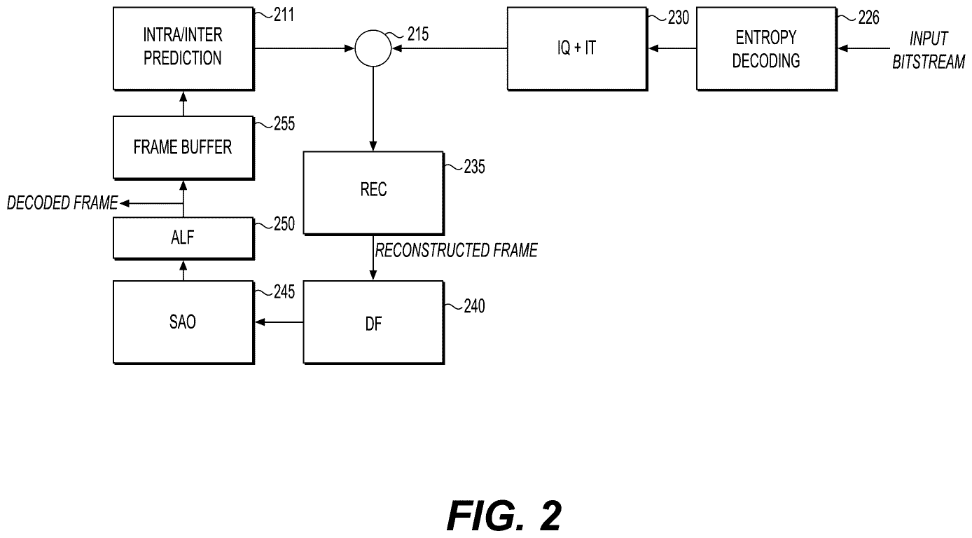

FIG. 2 shows a block diagram of a video decoder that can include or be coupled to a module or circuit implementing the methods and techniques described in the disclosure. The video decoder may be implemented based on the VVC standard, the HEVC standard (with ALF added) or any other video coding standard. Since the encoder contains a local decoder for reconstructing the video data, many decoder components are already used in the encoder except for the entropy decoder. At the decoder side, an Entropy Decoding unit 226 is used to recover coded symbols or syntax elements from the bitstream. The coded residues resulting from the entropy decoding process are processed by Inverse Quantization (IQ) and Inverse Transformation (IT) (IQ+IT, 230) to recover the residues. The process of generating the reconstructed residual from the input bitstream is referred as a residual decoding process in this disclosure. The prediction process for generating the Intra/Inter prediction data is also applied at the decoder side, however, the Intra/Inter prediction unit 211 is different from the Intra/Inter prediction unit 110 in the encoder side since the Inter prediction only needs to perform motion compensation using motion information derived from the bitstream. Furthermore, an Adder 215 is used to add the reconstructed residues to the Intra/Inter prediction data.

The present disclosure relates generally to video coding. In particular, the disclosure relates to the utilization of Template Matching (TM) and Bilateral Matching (BM, or Decoder-Side Motion Vector Refinement (DMVR)) within video encoding and decoding systems.

In ECM, the BM or DMVR process can include multiple passes. In the first pass, the bilateral matching process is applied to the coding block. In the second pass, the bilateral matching process is applied to each 16×16 subblock within the coding block. In the third pass, the MV in each 8×8 subblock is refined by applying Bi-Directional Optical Flow (BDOF). The refined MVs are stored for both spatial and temporal motion vector prediction.

Note that the concept of “early termination” can be incorporated into the multi-pass DMVR process. For instance, if the SAD resulting from the block-level BM pass falls below a certain threshold, the BM process can be prematurely concluded; there is no need to proceed with the subsequent subblock-level BM and BDOF procedures.

Each of the three passes are described in another section of this description in detail.

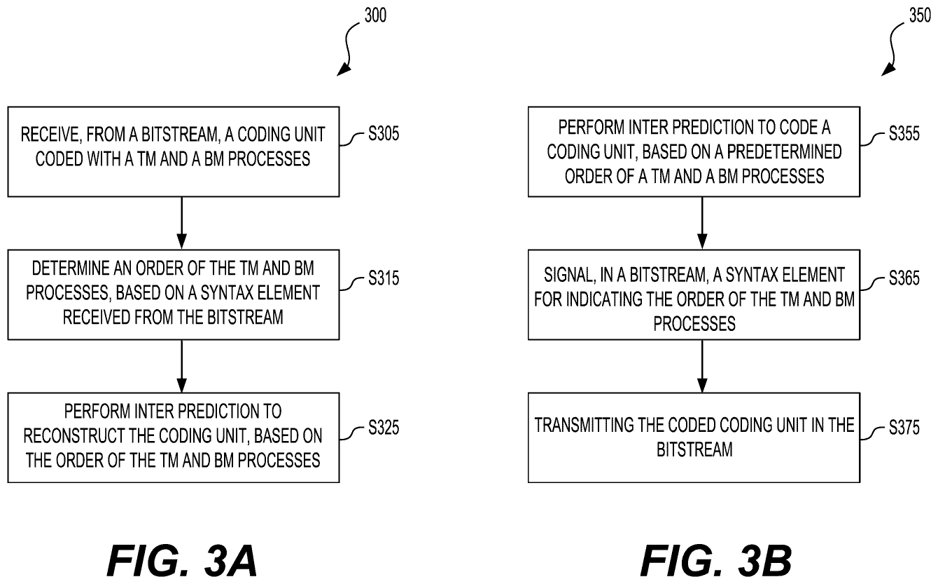

FIGS. 3A and 3B show flow charts of processes for performing inter prediction in a video decoder and a video encoder, respectively, in accordance with embodiments of the disclosure. TM and BM processes can be executed strategically to perform inter prediction, resulting in a reduction in coding complexity and an enhancement in coding performance.

The process 300 shown in FIG. 3A can be carried out in a video decoder. In step S305, a coding unit is received from a bitstream of a video. The coding unit is coded with a TM process and a BM process. In step S315, an order of the TM and BM processes is determined based on a syntax element received from the bitstream. In step S325, based on the determined order of the TM and BM processes, inter prediction is performed to reconstruct the coding unit.

In the embodiments shown in FIG. 3A, the order of performing the TM and BM processes is determined based on certain syntax element for indicating that order. However, those skilled in the art can recognize that a predefined order of the TM and BM processes can be used. In this case, no syntax elements are needed for the video decoder to parse.

The process 350 shown in FIG. 3B can be carried out in a video encoder. In step S355, based on a determined order of a TM process and a BM process, inter prediction is performed to code a coding unit. In step S365, a syntax element for indicating the order of the TM and BM processes is signaled in a bitstream of a video. In step S375, the coded coding unit is transmitted in the bitstream.

As mentioned above, a predefined order of performing the TM and BM processes can be used as the determined order. In such a scenario, no syntax elements are needed for the video encoder to signal.

Similar to the ECM 6.0 approach, the BM process can include, in a sequence, a block-level MV refinement, a subblock-level MV refinement, and a subblock-level BDOF MV refinement. In an embodiment, the TM process can be executed immediately after the block-level MV refinement of the BM process. In an alternative embodiment, the BM process can be executed after the TM process. Both embodiments can adopt early termination to enhance coding efficiency. In other words, whether a succeeding procedure is executed or not can be dependent on the cost of a preceding procedure.

As an example, consider a scenario where the TM process, if executed, is positioned immediately after the block-based (or CU-based) motion vector refinement of the BM process. In this case, if the minimum cost from the block-level MV refinement is less than or equal to a threshold, the TM process can be prohibited.

Alternatively, in the scenario where the TM process, if executed, is positioned immediately after the block-based (or CU-based) motion vector refinement of the BM process, when the minimum cost of the block-level MV refinement is less than or equal to a threshold, instead of prohibiting the TM process, the TM process can be performed, but with a smaller search range.

In another example, in the scenario where the TM process, if executed, is positioned immediately after the block-based (or CU-based) motion vector refinement of the BM process, the subblock-level MV refinement can be always performed, regardless of the cost of the block-level MV refinement.

For instance, as the TM process is performed immediately before the potential subblock-level MV refinement, if the cost of the TM process is less than or equal to a threshold, the subblock-level MV refinement can be prohibited.

Considering a scenario where the BM process, if executed, is positioned after the TM process, when the cost of the TM process is less than or equal to a threshold, the BM process can be prohibited, for example.

Alternatively, in the scenario where the BM process, if executed, is positioned after the TM process, when the cost of the TM process is less than or equal to a threshold, or the cost of the block-based MV refinement is less than or equal to a threshold, or the potential cost reduction achieved by the best block-level MV refinement is unable to be more than the cost reduction achieved by the initial block-level MV refinement (which is performed on the MVs derived from the TM process), the subblock-level MV refinement can be prohibited.

As another example, in the scenario where the BM process, if executed, is positioned after the TM process, when the cost of the block-level MV refinement is less than or equal to a threshold, or the potential cost reduction achieved by the best block-level MV refinement is unable to be more than the cost reduction achieved by the initial block-level MV refinement (which is performed on the MVs derived from the TM process), the MV modification from the BM process can be not used.

In the above examples, the cost can be calculated using a suitable function selected without restrictions. For instance, the cost from the block-level MV refinement can be calculated as the sum of the motion vector distance cost (mvDistanceCost) and the SAD cost (sadCost). However, those skilled in the art can recognize that other forms of cost are possible.

In the above examples, the threshold can be a predetermined non-negative integer.

Alternatively, the threshold can be adaptively determined based on the coding information. For instance, the threshold can be determined based on the count of the samples in the current block/CU, inter-dir, PoC of the reference picture and the current picture, quantization parameters (QP) of the reference picture and the current picture, the sample count of the template, etc.

Aspects of the present disclosure can be further described as follows.

### I. Video Coding Methods

### 1. Partitioning of the CTUs Using a Tree Structure

In High-Efficient Video Coding standard (HEVC), pictures are divided into a sequence of coding tree units (CTUs). A CTU consists of an N×N block of luma samples together with two corresponding blocks of chroma samples for a picture that has three sample arrays, or an N×N block of samples of a monochrome plane in a picture that is coded using three separate colour planes. The CTU concept is broadly analogous to that of the macroblock in previous standards such as Advanced Video Coding (AVC). The maximum allowed size of the luma block in a CTU is specified to be 64×64 in Main profile. A CTU is split into CUs by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four prediction units (PUs) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

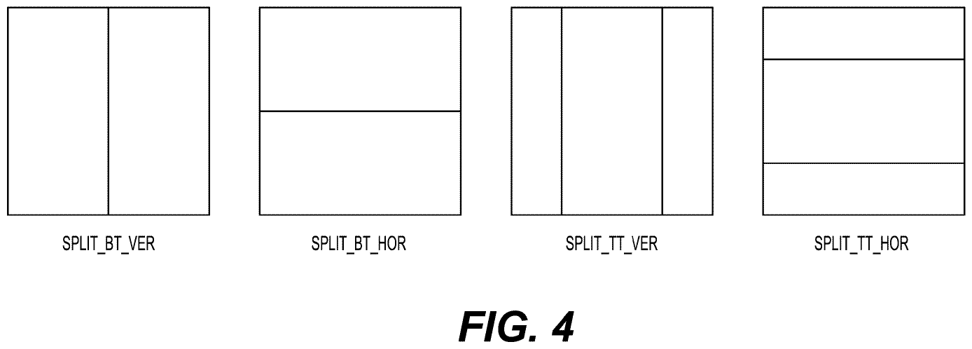

Versatile Video Coding standard (VVC) is the successor to HEVC. In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. FIG. 4 shows multiple types of tree splitting modes. As shown in FIG. 4, there are four splitting types in multi-type tree structure, vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

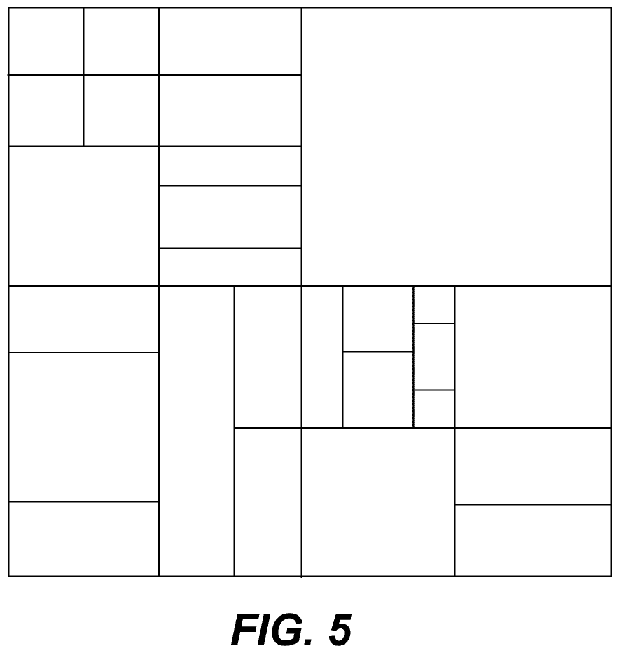

An example of quadtree with nested multi-type tree coding block structure is illustrated in FIG. 5. FIG. 5 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. ECM basically is the successor to VVC and thus it shares many common parts as VVC.

### 2. Inter Prediction Overview

In HEVC, for each inter PU, one of three prediction modes including inter, skip, and merge, can be selected. Generally speaking, a motion vector competition (MVC) scheme is introduced to select a motion candidate from a given candidate set that includes spatial and temporal motion candidates. Multiple references to the motion estimation allows finding the best reference in 2 possible reconstructed reference picture list (namely List 0 and List 1). For the inter mode (unofficially termed AMVP mode, where AMVP stands for advanced motion vector prediction), inter prediction indicators (List 0, List 1, or bi-directional prediction), reference indices, motion candidate indices, motion vector differences (MVDs) and prediction residual are transmitted. As for the skip mode and the merge mode, only merge indices are transmitted, and the current PU inherits the inter prediction indicator, reference indices, and motion vectors from a neighboring PU referred by the coded merge index. In the case of a skip coded CU, the residual signal is also omitted.

In VVC, AMVP mode is further improved by the new modes such as symmetric motion vector difference (SMVD) mode, adaptive motion vector resolution (AMVR) and affine AMVP mode; Merge/Skip modes are further improved by enhanced merge candidates, combined inter-intra prediction (CIIP), affine merge mode, subblock temporal motion vector predictor (SbTMVP), merge mode with motion vector difference (MMVD) and geometric partition mode (GPM). In VVC, a decoder-side motion vector refinement (DMVR), Bi-directional optical flow (BDOF) and prediction refinement with optical flow (PROF) are utilized to refine the motion vectors or the motion-compensated predictors at the decoder.

In ECM, several new coding tools are developed to further improve the AMVP, Merge and Skip mode such as Bilateral matching AMVP-Merge mode, multi-hypothesis prediction (MHP), overlapped block motion compensation (OBMC) and so on. Furthermore, templating matching based decoder side motion vector refinement is also proposed to enhanced the coding efficiency of the inter prediction.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

After VVC is finalized, the Enhanced Compression Model (ECM) reference software is developed to study the potential need for standardization of future video coding technology. In current

ECM, several inter-prediction coding tools are included to provide further BD-rate savings:
Local illumination compensation (LIC)
Non-adjacent spatial candidate
Template Matching (TM)
Overlapped Block Motion Compensation (OBMC)
Multi-hypothesis prediction (MHP)
Bilateral matching AMVP-Merge Mode
and some other tools under development

The following text provides the details on some selected inter prediction methods specified in VVC and ECM.

### 3. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merge candidate lists (or called as merging candidate lists) for all CUs within a certain size of area.

### 4. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1) The last two entries in the table are redundancy checked to A₁ and B₁ spatial candidates, respectively.
2) Once the total number of available merge candidates reaches the maximally allowed merge candidates minus 1, the merge candidate list construction process from HMVP is terminated.

### 5. Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

6. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signaled right after sending a regular merge flag to specify whether MMVD mode is used for a CU.

In MMVD, after a merge candidate is selected, it is further refined by the signaled MVDs information. The further information includes a merge candidate flag, an index to specify motion magnitude, and an index for indication of motion direction. In MMVD mode, one for the first two candidates in the merge list is selected to be used as MV basis. The mmvd candidate flag is signaled to specify which one is used between the first and second merge candidates.

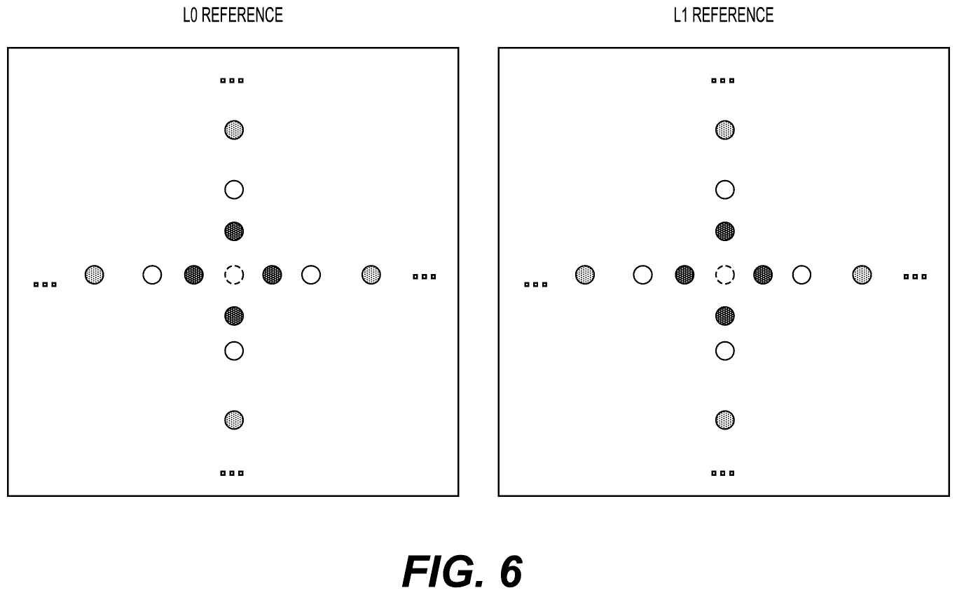

Distance index specifies motion magnitude information and indicate the pre-defined offset from the starting point. FIG. 6 shows a search point layout in merge mode with motion vector difference (MMVD). As shown in FIG. 6, an offset is added to either horizontal component or vertical component of starting MV. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2 specifies the sign of MV offset added to the list0 MV component of starting MV and the sign for the list1 MV has opposite value. Otherwise, if the difference of POC in list 1 is greater than list 0, the sign in Table 2 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 7. Affine Motion Compensated Prediction

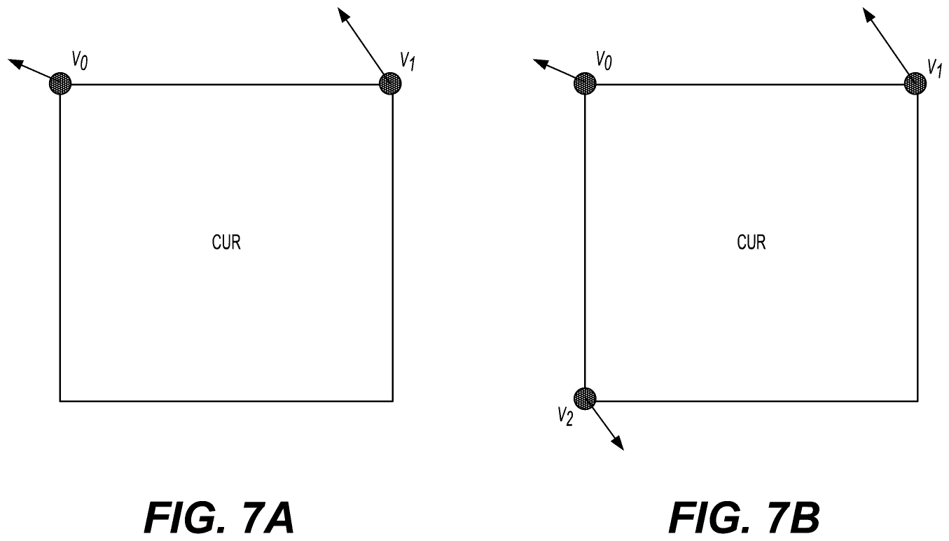

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIGS. 7A and 7B show control-point-based 4-parameter and 6-parameter affine motion models, respectively. As shown in FIGS. 7A and 7B, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 X} - m {v}_{0 x}}{W} y + m {v}_{0 y}\end{matrix} \qquad ( 3 - 1 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 3 - 2 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

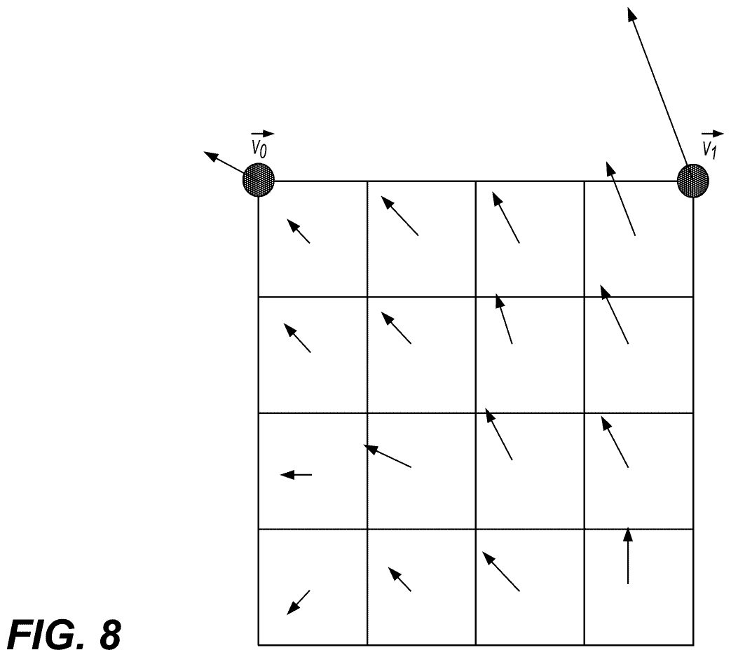

In order to simplify the motion compensation prediction, block based affine transform prediction is applied. FIG. 8 shows an example of an affine motion vector field (MVF) per subblock. To derive motion vector of each 4×4 luma subblock, the motion vector of the center sample of each subblock, as shown in FIG. 8, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 8. Affine Merge Prediction

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs
Constructed affine merge candidates CPMVPs that are derived using the translational MVs of the neighbour CUs
Zero MVs

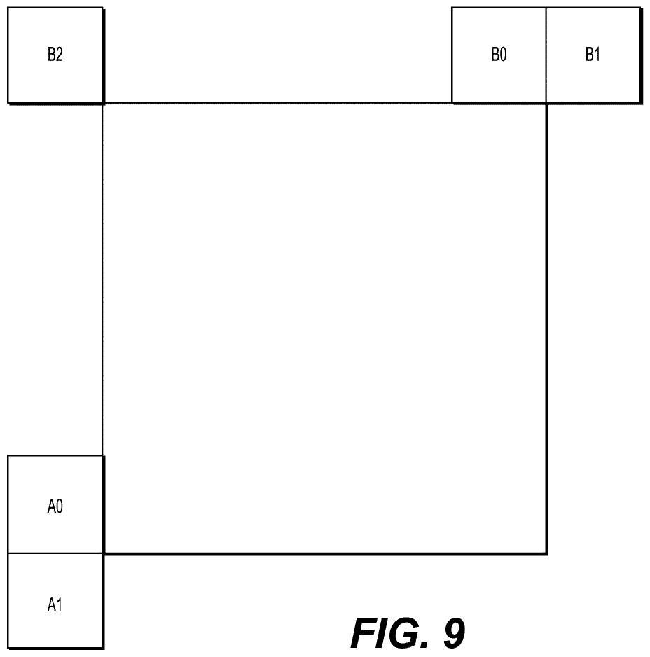

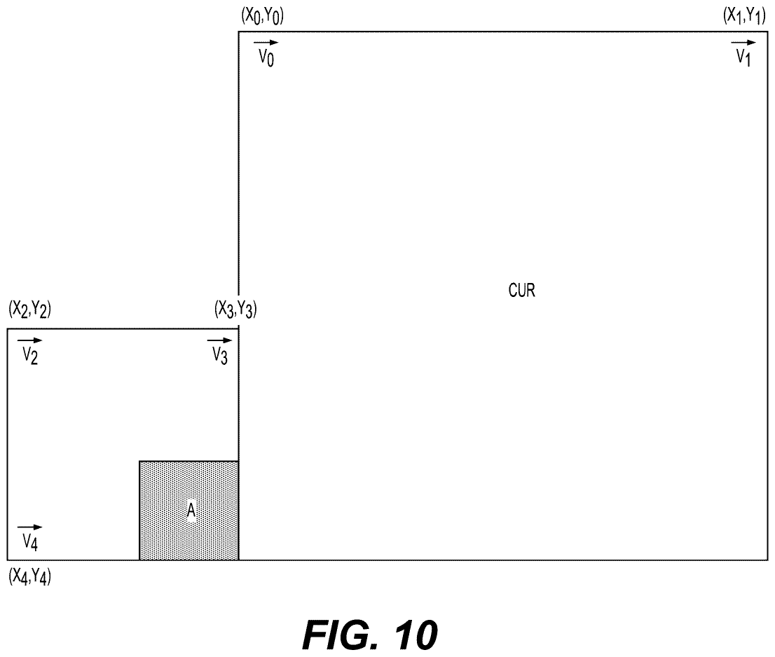

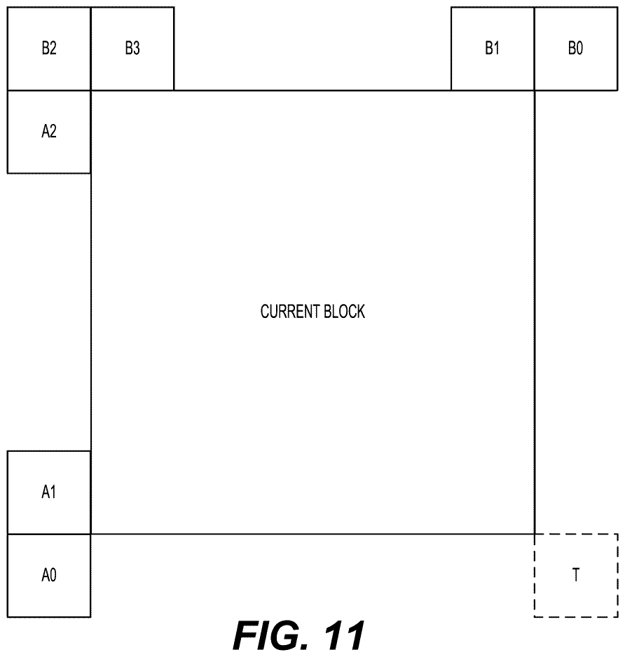

FIG. 9 shows locations of inherited affine motion predictors. FIG. 10 shows an example of control point motion vector inheritance. FIG. 11 shows locations of candidate positions for the constructed affine merge mode.

In VVC, there are maximum two inherited affine candidates, which are derived from affine motion model of the neighboring blocks, one from left neighboring CUs and one from above neighboring CUs.

The candidate blocks are shown in FIG. 9. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. As shown in FIG. 10, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbor translational motion information of each control point. The motion information for the control points is derived from the specified spatial neighbors and temporal neighbor shown in FIG. 11. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.

After MVs of four control points are attained, affine merge candidates are constructed based on those motion information. The following combinations of control point MVs are used to construct in order:
{CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 9. Decoder Side Motion Vector Refinement (DMVR)

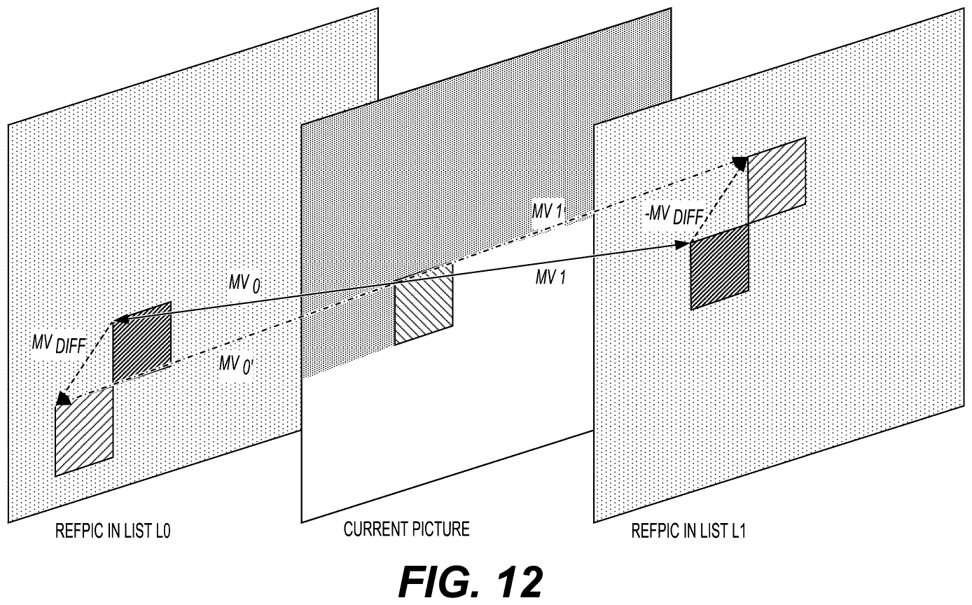

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 12 shows an example of decoding side motion vector refinement. As illustrated in FIG. 12, the SAD between the blocks filled with sparsely diagonally stripes based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 10. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2^{m} with m, n∈{3 . . . 6} excluding 8×64 and 64×8.

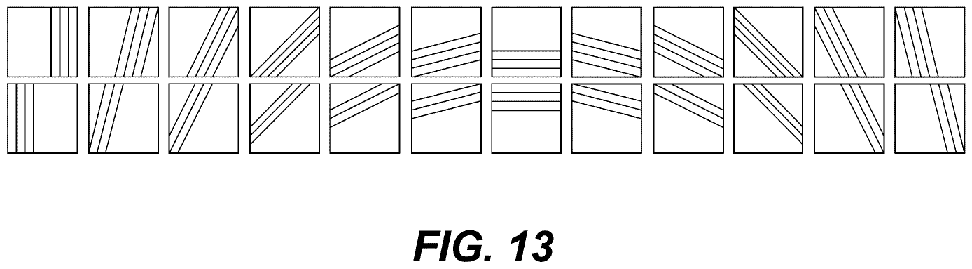

FIG. 13 shows examples of the geometric partition mode (GPM) splits grouped by identical angles. When this mode is used, a CU is split into two parts by a geometrically located straight line (FIG. 13). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 3.4.11.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 3.4.11.2. This is the prediction signal for the whole CU, and transform and quantization process will be applied to the whole CU as in other prediction modes. Finally, the motion field of a CU predicted using the geometric partition modes is stored as in 3.4.11.3.

### 11. Combined Inter and Intra Prediction (CIIP)

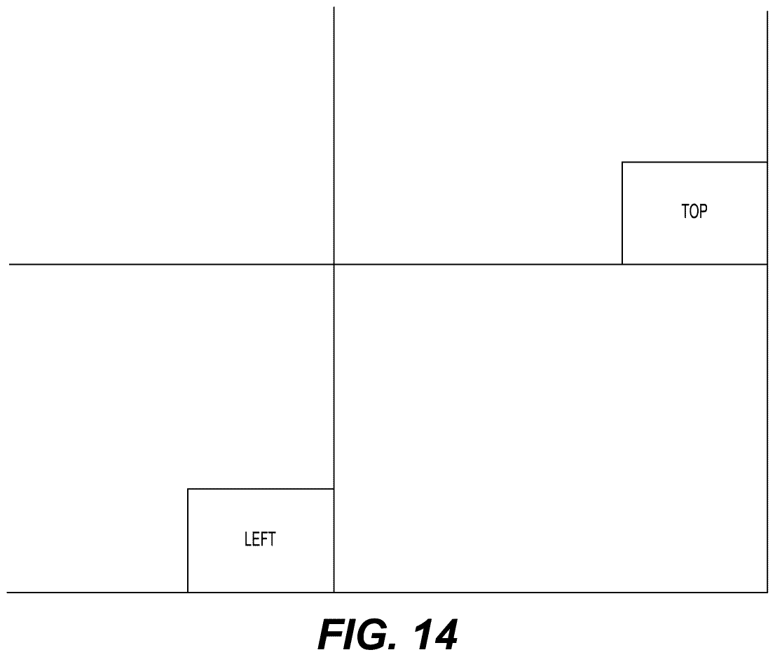

FIG. 14 shows top and left neighboring blocks used in combined inter-intra prediction (CIIP) weight derivation.

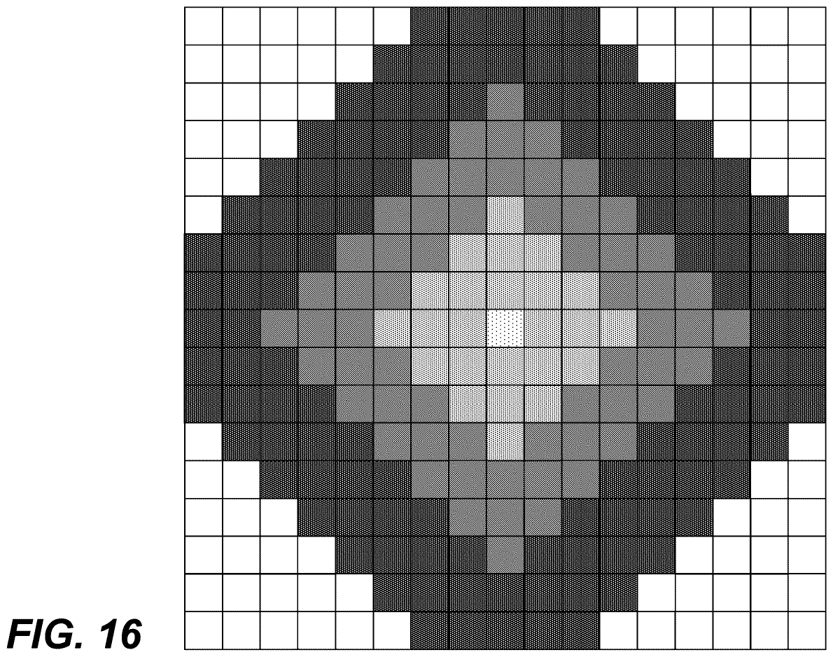

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 16) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{i n t e r} + w t * {P}_{i n t r a} + 2 ) ≫ 2 \qquad ( 3 - 3 )$$

### 12. Template Matching (TM)

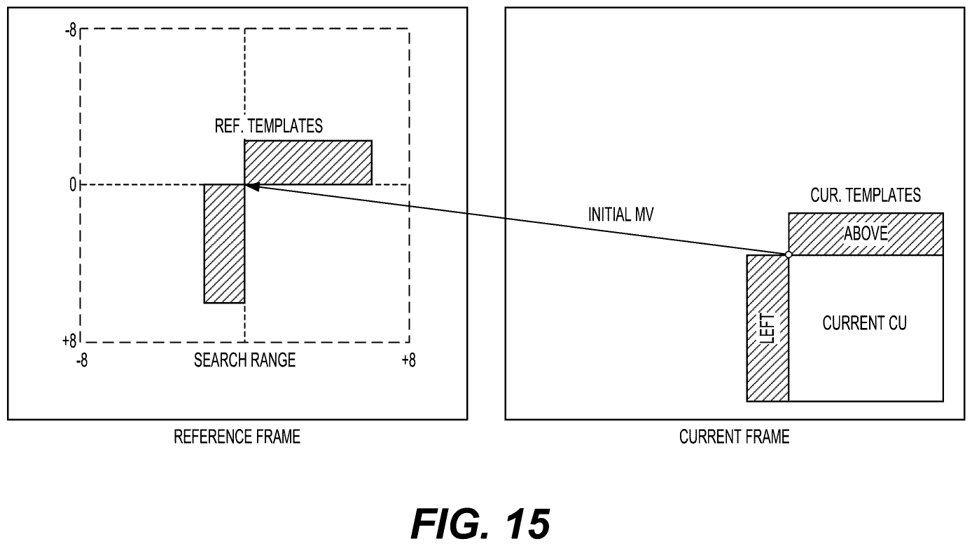

FIG. 15 shows template matching performed on a search area around initial motion vector (MV).

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 15, a better MV is searched around the initial motion of the current CU within a [−8, +8]-pel search range. The template matching method in JVET-J0021 is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 3
Search patterns of AMVR and merge mode with AMVR

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 3 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 13. Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### (1) First Pass-Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV$$

$$MV1\_pass1 = MV 1 - deltaMV$$

### (2) Second Pass-Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated by applying a cost factor to the SATD cost between two reference subblocks, as: bilCost=satdCost*costFactor. FIG. 16 shows diamond regions in the search area. The search area (2*sHor+1)*(2*sVer+1) is divided up to 5 diamond shape search regions shown on FIG. 16. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV (sbIdx2). The refined MVs at second pass is then derived as:

$$MV0\_pass2 ( s b Idx 2 ) = MV0\_pass1 + d e l t a M V ( s b Idx 2 )$$

$$MV1\_pass2 ( s b Idx 2 ) = MV1\_pass1 - d e l t a M V ( s b Idx 2 )$$

### (3) Third Pass-Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv (Vx, Vy) is rounded to 1/16 sample precision and clipped between −32 and 32.

The refined MVs (MV0_pass3 (sbIdx3) and MV1_pass3 (sbIdx3)) at third pass are derived as:

$$MV0\_pass3 ( s b Idx 3 ) = MV0\_pass2 ( s b I d x 2 ) + bioMv$$

$$MV1\_pass3 ( s b Idx 3 ) = MV0\_pass2 ( s b I d x 2 ) - bioMv$$

### 14. Bilateral Matching AMVP-Merge Mode

The bi-directional predictor is composed of an AMVP predictor in one direction and a merge predictor in the other direction. The mode can be enabled to a coding block when the selected merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP part of the mode is signaled as a regular uni-directional AMVP, i.e. reference index and MVD are signaled, and it has a derived MVP index if template matching is used or MVP index is signaled when template matching is disabled.

For AMVP direction LX, X can be 0 or 1, the merge part in the other direction (1−LX) is implicitly derived by minimizing the bilateral matching cost between the AMVP predictor and a merge predictor, i.e. for a pair of the AMVP and a merge motion vectors. For every merge candidate in the merge candidate list which has that other direction (1−LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

When bilateral matching (BM) AMVP-merge mode is used for the current block and template matching is enabled, MVD is not signalled. An additional pair of AMVP-merge MVPs is introduced. The merge candidate list is sorted based on the BM cost in increase order. An index (0 or 1) is signaled to indicate which merge candidate in the sorted merge candidate list to use. When there is only one candidate in merge candidate list, the pair of AMVP MVP and merge MVP without bilateral matching MV refinement is padded.

### II. Proposed Method

In ECM 6.0, when TM mode is enabled, template matching may work as an independent process or an extra MV refinement process between block-based and subblock-based bilateral matching (BM) methods, depending on whether BM can be enabled or not according to its enabling condition check.

In this invention, several methods are proposed to improve the TM in terms of complexity reduction or coding performance increase.

In the first embodiment of this invention, when bilateral matching (BM) is enabled for a TM mode coded block/CU and the minimum cost of the block-based (or CU-based) BM is less than or equal to a threshold TH, the TM process is prohibited.

In the second embodiment of this invention, when bilateral matching (BM) is enabled for a TM mode coded block/CU and the minimum cost of the block-based (or CU-based) BM is less than or equal to a threshold TH, the search range of TM process is set to a smaller range.

In the third embodiment of this invention, when bilateral matching (BM) is enabled for a TM mode coded block/CU, the subblock-based BM is always performed regardless of the cost of the block-based BM.

In the fourth embodiment of this invention, when bilateral matching (BM) is enabled for a TM mode coded block/CU, the subblock-based BM is prohibited when the cost of the TM is less than or equal to a threshold TH.

In the fifth embodiment of this invention, when bilateral matching (BM) is enabled for a TM mode coded block/CU, TM is first preformed followed by the block-based BM and sub-block based BM.

In the sixth embodiment of this invention, when bilateral matching (BM) is enabled for a TM mode coded block/CU, TM is first preformed followed by the block-based BM and sub-block based BM. The BM process including block-base and subblock-based BM are prohibited when the cost of the TM is less than or equal to a threshold TH.

In the seventh embodiment of this invention, when bilateral matching (BM) is enabled for a TM mode coded block/CU, TM is first preformed followed by the block-based BM and sub-block based BM. The subblock-based BM is prohibited when the cost of the TM is less than or equal to a threshold TH, or when cost of the block-based BM is less than or equal to a threshold, or the cost of the best block-based BM cannot be reduced more than or equal to a threshold than the cost of the initial block-based BM (MV inherited from the TM).

In the eighth embodiment of this invention, when bilateral matching (BM) is enabled for a TM mode coded block/CU, TM is first preformed followed by the block-based BM and sub-block based BM. The MV modification from BM is not used when cost of the block-based BM is less than or equal to a threshold, or the cost of the best block-based BM cannot be reduced more than or equal to a threshold than the cost of the initial block-based BM (MV inherited from the TM).

In the mentioned methods, TH could be any non-negative integer. Yet in another scheme, TH could be adaptive based on the coding information. For example, the TH could be related to the count of the samples in current block/CU, inter-dir, PoC of reference picture and current picture, QP of reference picture and current picture, the sample count of the template.

Any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

Those skilled in the art will also understand that there can be many variations made to the operations of the techniques explained above while still achieving the same objectives of the disclosure. Such variations are intended to be covered by the scope of this disclosure. As such, the foregoing descriptions of embodiments of the disclosure are not intended to be limiting. Rather, any limitations to embodiments of the disclosure are presented in the following claims.

What is claimed is:

1. A method for performing inter prediction in a video decoder, comprising:
receiving a coding unit in a bitstream of a video, the coding unit being coded with a Template Matching (TM) process and a Bilateral Matching (BM) process;
determining an order of the TM and BM processes; and
performing, based on the determined order of the TM and BM processes, inter prediction to reconstruct the received coding unit.

2. The method of claim 1, wherein the determining step further comprises:
determining a predefined order of the TM and BM processes, as the determined order of the TM and BM processes, or
determining, based on a syntax element included in the bitstream, an order of the TM and BM processes, as the determined order of the TM and BM processes.

3. The method of claim 1, wherein
the BM process includes, in a sequence, a block-level motion vector (MV) refinement, a subblock-level MV refinement, and a subblock-level bi-directional optical flow (BDOF) MV refinement, where whether a succeeding refinement is performed or not is dependent on a cost of a preceding refinement, and
the TM process, when performed, is performed right after the block-level MV refinement of the BM process.

4. The method of claim 3, wherein in response to a minimum cost of the block-level MV refinement being less than or equal to a threshold, the TM process is prohibited.

5. The method of claim 4, wherein the threshold is a non-negative integer, and a value of the threshold is predefined or adaptable based on the coding unit.

6. The method of claim 3, wherein in response to a minimum cost of the block-level MV refinement being less than or equal to a first threshold, the TM process is performed with a search range smaller than a second threshold.

7. The method of claim 3, wherein the subblock-level MV refinement is performed after the TM process, regardless of a cost of the block-level MV refinement.

8. The method of claim 3, wherein in response to a cost of the TM process being less than or equal to a threshold, the subblock-level MV refinement is prohibited.

9. The method of claim 2, wherein
the BM process includes, in a sequence, a block-level motion vector (MV) refinement, a subblock-level MV refinement, and a subblock-level bi-directional optical flow (BDOF) MV refinement, where whether a succeeding refinement is performed or not is dependent on a cost of a preceding refinement, and
the BM process, when performed, is performed after the TM process.

10. The method of claim 9, wherein in response to a cost of the TM process being less than or equal to a threshold, the BM process is prohibited.

11. The method of claim 9, wherein in response to a cost of the TM process being less than or equal to a third threshold, or a cost of the block-level MV refinement being less than or equal to a fourth threshold, or a cost reduction of a best block-level MV refinement being unable to be more than a cost reduction of an initial block-level MV refinement, the subblock-level MV refinement is prohibited.

12. The method of claim 9, wherein in response to a cost of the block-level MV refinement being less than or equal to a sixth threshold, or a cost reduction of a best block-level MV refinement being unable to be more than a cost reduction of an initial block-level MV refinement, usage of an MV modification from the BM process is prohibited.

13. A method for performing inter prediction in a video encoder, comprising:
performing, based on a determined order of a Template Matching (TM) process and a Bilateral Matching (BM) process, inter prediction to code a coding unit; and
transmitting the coded coding unit in a bitstream of a video.

14. The method of claim 13, wherein the performing step further comprises determining a predefined order of the TM and BM processes, as the determined order of the TM and BM processes, or
the performing step further comprises deciding an order of the TM and BM processes, and the transmitting step further comprises transmitting, in the bitsteam, a syntax element for indicating the decided order of the TM and BM processes.

15. The method of claim 13, wherein
the BM process includes, in a sequence, a block-level motion vector (MV) refinement, a subblock-level MV refinement, and a subblock-level bi-directional optical flow (BDOF) MV refinement, where whether a succeeding refinement is performed or not is dependent on a cost of a preceding refinement, and
the TM process, when performed, is performed right after the block-level MV refinement of the BM process.

16. The method of claim 15, wherein in response to a minimum cost of the block-level MV refinement being less than or equal to a threshold, the TM process is prohibited.

17. The method of claim 16, wherein the threshold is a non-negative integer, and a value of the threshold is predefined or adaptable based on the coding unit.

18. The method of claim 15, wherein in response to a minimum cost of the block-level MV refinement being less than or equal to a first threshold, the TM process is performed with a search range smaller than a second threshold.

19. The method of claim 15, wherein the subblock-level MV refinement is performed after the TM process, regardless of a cost of the block-level MV refinement.

20. The method of claim 15, wherein in response to a cost of the TM process being less than or equal to a threshold, the subblock-level MV refinement is prohibited.

21. The method of claim 13, wherein
the BM process includes, in a sequence, a block-level motion vector (MV) refinement, a subblock-level MV refinement, and a subblock-level bi-directional optical flow (BDOF) MV refinement, where whether a succeeding refinement is performed or not is dependent on a cost of a preceding refinement, and
the BM process, when performed, is performed after the TM process.

22. The method of claim 21, wherein in response to a cost of the TM process being less than or equal to a threshold, the BM process is prohibited.

23. The method of claim 21, wherein
the subblock-level MV refinement is prohibited in response to one of the following conditions:
a cost of the TM process being less than or equal to a third threshold,
a cost of the block-level MV refinement being less than or equal to a fourth threshold, or
a cost reduction of a best block-level MV refinement being unable to be more than a cost reduction of an initial block-level MV refinement.

24. The method of claim 21, wherein in response to a cost of the block-level MV refinement being less than or equal to a sixth threshold or a cost reduction of a best block-level MV refinement being unable to be more than a cost reduction of an initial block-level MV refinement, an MV modification from the BM process is prohibited.
